(19) United States
(12) Patent Application Publication
(10) Pub. No.: US 2015/0356617 A1
(43) Pub. Date: Dec. 10, 2015

(54) MOBILE COMPUTING DEVICE DISPLAYING A USER INTERFACE THAT INCLUDES USER CUSTOMIZED CONTENT

(71) Applicant: TOSHIBA TEC KABUSHIKI KAISHA, Tokyo (JP)

(72) Inventor: Koichi SUGIYAMA, Izunokuni Shizuoka (JP)

(21) Appl. No.: 14/733,312

(22) Filed: Jun. 8, 2015

(30) Foreign Application Priority Data
Jun. 10, 2014 (JP) 2014-119750

(51) Int. Cl. G06Q 30/02; H04L 29/08; G06Q 40/00; G06F 3/0484

(52) U.S. Cl. CPC G06Q 30/0267; G06F 3/04847; G06F 3/04842; H04L 67/306; H04L 67/22; G06Q 40/12

(57) ABSTRACT

A mobile computing device includes a wireless communication unit connected to a central server, a touch screen, and a processing unit that is programmed to generate a user interface on the touch screen. The user interface includes a plurality of elements that trigger the processing unit to execute instructions when touched. A touching of one of the elements causes the processing unit to generate an updated user interface displaying an element associated with content prompting a future transaction. The content is generated at the central server according to user profile data. The content generated at the first time has a higher correlation to the user profile data at the first time than that at the second time, and the content generated at the second time has a higher correlation to the user profile data at the second time than that at the first time.

### CROSS-REFERENCE TO RELATED APPLICATION

This application is based upon and claims the benefit of priority from Japanese Patent Application No. 2014-119750, filed Jun. 10, 2014, the entire contents of which are incorporated herein by reference.

### FIELD

An embodiment described herein relates to a mobile computing device, in particular, a mobile computing device displaying a user interface that includes content prompting a future transaction.

### BACKGROUND

An electronic receipt system of one type transmits electronic data of a purchase transaction at a store (i.e., an electronic receipt) to a computing device of a customer, such as a mobile device, instead of printing a conventional paper receipt that is handed to the customer upon completion of the purchase transaction. The computing device that receives the electronic data can display the electronic receipt on a display unit thereof.

The electronic receipt is useful to the customer, because the customer can manage his or her purchase transactions electronically. Further, the electronic receipt is useful to the store, because the store can reduce paper usage and with full conversion, will not need to invest in machines that issue the paper receipt. In addition, providing electronic receipts instead of paper receipts may reduce the time necessary to carry out settlement processing for the purchase transaction.

In addition to the electronic receipt, additional contents (e.g., promotional contents), such as a coupon and advertisement, may be displayed on the display unit of the computing device. A user interface that efficiently displays such additional contents and promotional contents are desirable because it is more likely to lead to a future transaction by the customer.

### DESCRIPTION OF THE DRAWINGS

FIG. 1 illustrates an entire configuration of an electronic receipt system according to an embodiment.

FIG. 2 is a block diagram of a point of sales (POS) terminal in the electronic receipt system.

FIG. 3 is a block diagram of an electronic receipt server in the electronic receipt system.

FIG. 4 is a block diagram of an electronic receipt management server in the electronic receipt system.

FIG. 5 is a block diagram of a mobile terminal in the electronic receipt system.

FIG. 6 is a flowchart illustrating a flow of electronic receipt processing carried out by the POS terminal.

FIG. 7 is a flowchart illustrating a flow of electronic receipt management processing and information transmission processing carried out by the electronic receipt server.

FIG. 8 is a functional block diagram according to electronic receipt management processing and information transmission processing carried out by the electronic receipt management server.

FIG. 9 is a flowchart illustrating a flow of electronic receipt management processing and information transmission processing carried out by the electronic receipt management server.

FIG. 10 illustrates functional blocks generated in the mobile terminal to perform electronic receipt reception processing and electronic receipt display processing.

FIG. 11 is a flowchart illustrating a flow of the electronic receipt reception processing and the electronic receipt display processing carried out by the mobile terminal.

FIG. 12 illustrates an example of an electronic receipt displayed on a display unit of the mobile terminal.

FIG. 13 illustrates another example of the electronic receipt displayed on the display unit of the mobile terminal.

FIG. 14 illustrates an example of a list of purchase incentive information displayed on the display unit of the mobile terminal.

### DETAILED DESCRIPTION

An embodiment provides an electronic receipt management server and a program with which a retail seller or a consumer goods manufacturer may perform a promotion according to a past purchase history.

In general, according to one embodiment, a mobile computing device that is connected to a central server over a network, includes a wireless communication unit through which requests are transmitted to the central server and responses are received from the central server, a touch screen on which a graphical user interface is displayed, and a processing unit that is programmed to generate the graphical user interface on the touch screen. The graphical user interface includes a plurality of user interface elements, and each of the user interface elements triggers the processing unit to execute instructions that are predetermined to be executed when the user interface element is touched. A touching of one of the user interface elements causes the processing unit to generate an updated graphical user interface displaying a user interface element associated with content prompting a future transaction. The content is generated remotely at the central server according to user profile data that has been collected over time by the central server, such that the content generated remotely at the central server at a first time is different from the content generated remotely at the central server at a second time subsequent to the first time. The content generated remotely at the central server at the first time has a higher correlation to the user profile data at the first time than the user profile data at the second time, and the content generated remotely at the central server at the second time has a higher correlation to the user profile data at the second time than the user profile data at the first time.

Hereinafter, an embodiment will be described with reference to the drawings.

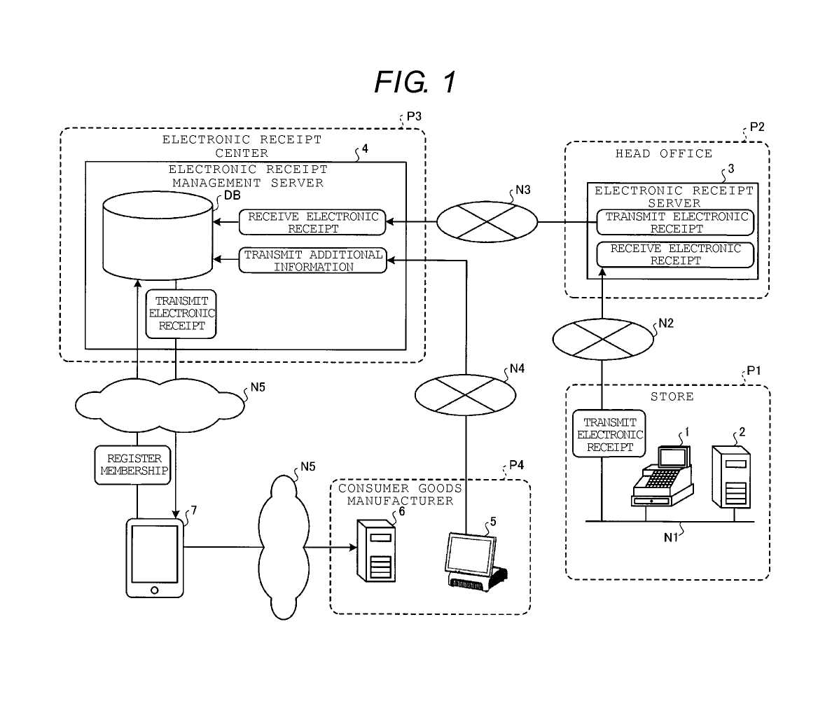

FIG. 1 illustrates an entire configuration of an electronic receipt system according to an embodiment. As illustrated in FIG. 1, the electronic receipt system includes a Point of Sales (POS) terminal 1, a store server 2, an electronic receipt server 3, an electronic receipt management server 4, an incentive setting terminal 5, an incentive management server 6, and a mobile terminal 7.

The POS terminal 1 and the store server 2 are located in a store P1. The POS terminal 1 and the store server 2 are connected to a network N1 such as a Local Area Network (LAN) in the store P1 to communicate with each other. In addition, the POS terminal 1 and the store server 2 are configured to be connected to a network N2, which connects the store P1 and a head office P2 through a network equipment (not illustrated) such as a router, which is connected to the network N1 in the store P1. Here, the network N2, for example, is a dedicated line such as the Internet or a Virtual Private Network (VPN).

The POS terminal 1 is a merchandise sales data processing device and performs merchandise sales data processing. The POS terminal 1 generates receipt data including content of a purchase transaction, and outputs a paper receipt by printing the receipt data using a printer 13. In addition, the POS terminal 1 outputs (transmits) an electronic receipt in which a data format of the receipt data has been converted to the electronic receipt server 3, through the network N2. A transmission method of an electronic receipt is not particularly limited, and a general-purpose protocol such as HTTP or HTTPS may be used. Furthermore, the number of POS terminals 1 provided in the store P1 is not particularly limited, and a plurality of POS terminals 1 may be provided.

The store server 2 integrally performs management of operations, such as the merchandise sales data processing, which are performed in the POS terminal 1. For example, the store server 2 stores and manages merchandise sales data which is generated through the merchandise sales data processing in the POS terminal 1, or stores and manages a merchandise data file or the like which is used during the merchandise sales data processing.

In this embodiment the POS terminal 1 outputs the electronic receipt, but the configuration is not limited thereto. For example, the data format of the receipt data generated by the POS terminal 1 may be converted by the store server 2 or a conversion device (not illustrated), and the receipt data may be output to the electronic receipt server 3 as an electronic receipt.

The electronic receipt server 3 is located in the head office P2 of a company which operates one or more stores P1 or chain stores, and functions as a receipt management server for the company. The electronic receipt server 3, for example, has a function to perform operations, such as sales management, sales analysis, and inventory management of the company.

In addition, the electronic receipt server 3 receives the electronic receipt from the POS terminal 1 through the network N2. In addition, the electronic receipt server 3 transmits the received electronic receipt to the electronic receipt management server 4 through a network N3, which connects the head office P2 and an electronic receipt center P3.

Here, the network N3, for example, is a dedicated line such as the Internet or VPN. In addition, a transmission method of an electronic receipt is not particularly limited, and a general-purpose protocol such as HTTP or HTTPS may be used.

The electronic receipt management server 4 is located in the electronic receipt center P3. The electronic receipt center P3, for example, is a third-party organization other than the company managing the receipt data using the electronic receipt server 3. Alternatively, the third-party organization or the like may also manage the electronic receipt server 3.

The electronic receipt management server 4 functions as a receipt management server for customers and collectively manages the receipt data of multiple companies each of which operates one or more stores. The electronic receipt management server 4 stores membership data such as name and a member code of each customer (member) who has completed membership registration, and transmission destination information (for example, an email address) associated with the mobile terminal 7, which is a transmission destination of the electronic receipt, in a membership master maintained in database DB, and manages the data. Furthermore, a membership management server or the like which stores and manages the membership data may be provided separately from the electronic receipt management server 4.

In addition, the electronic receipt management server 4 receives the electronic receipt transmitted from the electronic receipt server 3 through the network N3, stores the electronic receipt in an electronic receipt management region 43a in the database DB, and manages the electronic receipt. The electronic receipt includes a member code in addition to the content (merchandise sales data) of the purchase transaction, and is managed in correlation with the membership data of the corresponding member.

In addition, the electronic receipt management server 4 receives additional information such as purchase incentive information added based on purchase information of a shopper, from the incentive setting terminal 5 which is connected through a network N4, stores the additional information in an additional information management region 43b maintained in the database DB, and manages the additional information. More specifically, the additional information is managed in correlation with an element satisfying predetermined conditions among elements included in the electronic receipt stored in the database DB.

In addition, when the electronic receipt is stored in the database DB, the electronic receipt management server 4 specifies the transmission destination (the mobile terminal 7) by reference to the transmission destination information correlated with the member code of the electronic receipt. Then, the electronic receipt management server 4 transmits the electronic receipt stored in the database DB to the transmission destination through a network N5. Furthermore, when additional information is correlated with the electronic receipt, the additional information is also transmitted to the transmission destination.

When an electronic receipt inquiry designating a specific member code is received from the mobile terminal 7 which is connected through the network N5, the electronic receipt management server 4 extracts an electronic receipt corresponding to the member code from the database DB, and transmits the electronic receipt to the mobile terminal 7. Furthermore, when the additional information is correlated with the electronic receipt, the additional information is also transmitted to the mobile terminal 7 which has transmitted the inquiry.

The incentive setting terminal 5 and the incentive management server 6 are located in a consumer goods manufacturer P4 or the like. The incentive setting terminal 5 is a terminal device such as a Personal Computer (PC), and transmits the additional information to the electronic receipt management server 4 through the network N4. Here, the network N4, for example, is a dedicated line such as the Internet or a Virtual Private Network (VPN). In addition, a transmission method of the additional information is not particularly limited, and a general-purpose protocol such as HTTP or HTTPS may be used.

The consumer goods manufacturer P4 stores and manages incentive providing conditions to the shoppers (members) in the additional information management region 43b of the electronic receipt management server 4 in advance through the incentive setting terminal 5, which is an interface for a consumer goods manufacturer, and is prepared on the electronic receipt system. The incentive providing conditions to the shoppers (members) may be purchase of target merchandise, total value of purchase over a threshold value, a total quantity of target merchandise purchased.

The mobile terminal 7 is a terminal device such as a smart phone, a mobile phone, Personal Digital Assistant (PDA), or a tablet computer which is used by a user (customer) of the electronic receipt system. The mobile terminal 7 implements an application such as a Web browser for displaying various kinds of information provided on the network N5. Furthermore, a terminal device such as PC may be used instead of the mobile terminal 7.

The mobile terminal 7 accesses the electronic receipt management server 4 through the network N5, and performs the membership registration to the electronic receipt system. Here, the network N5 is the Internet or various public networks.

However, the membership registration of the customer in the electronic receipt system, for example, is performed according to the following procedure. The customer transmits a blank mail to the electronic receipt management server 4 from the mobile terminal 7 through the network N5. The electronic receipt management server 4 transmits a Uniform Resource Locator (URL) of a webpage for the membership registration to the received email address. The customer accesses the webpage for the membership registration from the mobile terminal 7 by designating the URL, and displays an input screen to input information (name, transmission destination information, and the like) necessary for the membership registration. After the input of the necessary information by the customer, the electronic receipt management server 4 performs the membership registration with respect to the membership master. After that, the electronic receipt management server 4 delivers a membership registration completion mail including a member code (customer code) and a password to the mobile terminal 7. Accordingly, the membership registration is terminated.

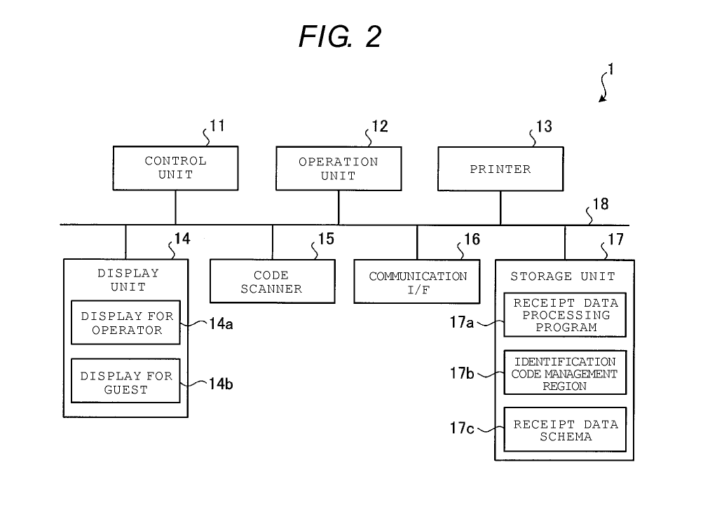

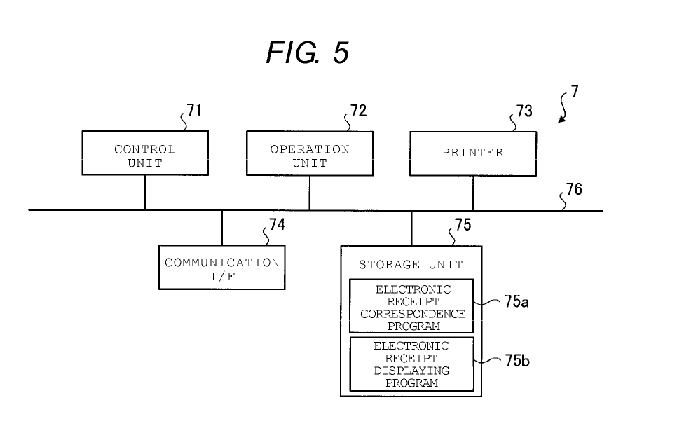

After the membership registration as described above, the mobile terminal 7 displays the member code of the customer on a display unit 73 (refer to FIG. 5) as a code symbol such as a bar code or a two-dimensional code. The customer exhibits the code symbol displayed on the mobile terminal 7 to a salesperson during the purchase transaction in the store P1. The salesperson scans the code symbol displayed on the mobile terminal 7 using a code scanner 15 (refer to FIG. 2) connected to the POS terminal 1. As a result, the member code of the customer may be correlated with the receipt data generated after the payment according to the merchandise sales data processing in the POS terminal 1.

After the payment (purchase transaction) in the POS terminal 1, the mobile terminal 7 receives the electronic receipt of the transaction from the electronic receipt management server 4 through the network N5. The electronic receipt inquiry designating the member code is transmitted to the electronic receipt management server 4 through the network N5, and the electronic receipt of the member is received from the electronic receipt management server 4. Then, the mobile terminal 7 displays the received electronic receipt on the display unit 73.

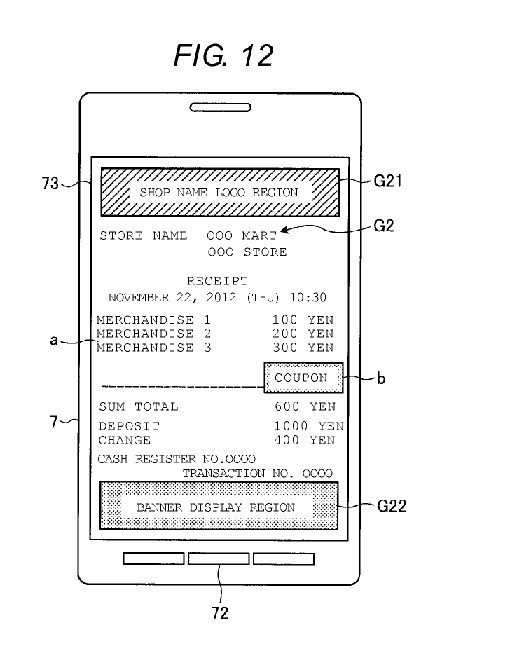

Further, when the additional information is correlated with the received electronic receipt, the mobile terminal 7 displays icon indicating that a purchase incentive has been acquired, in accordance with the additional information or the like (refer to FIG. 12). For example, connection destination information (URL or the like) indicating a destination to acquire the purchase incentive (for example, the incentive management server 6) may be associated with the icon. In this case, when the icon is operated, the mobile terminal 7 accesses the incentive management server 6 through the network N5, and performs processing related the acquisition of the purchase incentive.

The incentive management server 6 is a server device which receives the access from the mobile terminal 7 connected through the network N5. The incentive management server 6 manages the purchase incentive information to be added to the electronic receipt based on the purchase information of the shopper (member). When a request to acquire the purchase incentive is received from the mobile terminal 7 through the network N5, the incentive management server 6 manages acquisition history of the purchase incentive associated with the member code for identifying the member. Furthermore, the mobile terminal 7 transmits a member code of the user (member) of the own device, which is maintained in the receipt data or the like, when accessing the incentive management server 6.

In the electronic receipt system according to the present embodiment, the electronic receipt (receipt data) indicating the content of the purchase transaction (payment) generated through the merchandise sales data processing in the POS terminal 1 of the store P1 is transmitted to the electronic receipt management server 4 through the electronic receipt server 3, and is uploaded on the Web. By designating the Uniform Resource Locator (URL) using the Web browser, the mobile terminal 7 may download the receipt data uploaded on the Web display thereon. Furthermore, an application for displaying the receipt data, different from the Web browser, on the mobile terminal 7 may be installed and displayed.

Next, the configuration of main devices configuring the electronic receipt system of the present embodiment will be described.

First, the POS terminal 1, which is the merchandise sales data processing device, will be described. FIG. 2 is a block diagram of the POS terminal 1. As illustrated in FIG. 2, the POS terminal 1 includes a control unit 11 which integrally controls various calculations or each unit of the POS terminal 1. The control unit 11 includes a Central Processing Unit (CPU), a Read Only Memory (ROM) storing various programs or data items, a Random Access Memory (RAM) that temporarily stores various programs or rewritably stores various data, a Real Time Clock (RTC) unit that indicates current date and time, and the like.

The control unit 11 is connected to an operation unit 12, a printer 13, a display unit 14, and the code scanner 15, through a bus 18.

The operation unit 12 includes various operation keys for an operator to perform input operations. The operation keys include, for example, a register key for inputting a numerical value, a cursor key for selecting a predetermined item, or a selection determination key, a subtotal key indicating subtotal of the merchandise for which sales registration has been performed in the purchase transaction, a settlement key to close (fix) the purchase transaction, and the like.

The printer 13 is a printer device printing the receipt, a journal, or the like. The printer 13 includes a cutting mechanism (not illustrated) to cut paper such as rolled paper which is a printing target, according to a cut command.

The display unit 14, for example, is a liquid crystal display or the like, and displays various kinds of information, such as the product name of the merchandise subjected to the sales registration, the price, a total price of one purchase transaction, and a change sum. The display unit 14 includes a display 14a for an operator which displays various kinds of information to a cashier, and a display 14b for a guest which displays various kinds of information to the customer. Furthermore, the display unit 14 may have a touch panel, and in this case, the touch panel functions as the operation unit 12.

The code scanner 15 is a scanner device optically reading the code symbol such as a bar code or a two-dimensional code. The code scanner 15, for example, reads a code symbol printed on the merchandise, a code symbol displayed on the mobile terminal 7, or the like, and outputs information contained in the code symbol to the control unit 11. Here, in the code symbol printed on the merchandise, a merchandise code for specifying the merchandise or the like is contained. In addition, in the code symbol displayed on the mobile terminal 7, a member code (customer code) for specifying the customer carrying the mobile terminal 7 or the like is contained.

In addition, the control unit 11 is connected to a communication I/F (interface) 16 through the bus 18, and is configured to be connected to the network N1 or the network N2 in the store P1 through the communication I/F 16.

The control unit 11 is also connected to the storage unit 17 through the bus 18. The storage unit 17, for example, is an auxiliary storage device such as Hard Disk Drive (HDD) or Solid State Drive (SSD). The storage unit 17 stores a program for performing various POS operations including the merchandise sales data processing. The storage unit 17 also stores various data files related to the merchandise sales data processing, such as a merchandise data file including the merchandise data such as the merchandise name of each of the merchandise, the merchandise code, and the unit price. In addition, the storage unit 17 stores a receipt data processing program 17a for performing the merchandise sales data processing or processing related the receipt data.

The storage unit 17 also stores a POS number for identifying the own POS terminal 1, a company code (an identification code of the company which operates the store), a business type and business category code, a store code of the store P1 in which the POS terminal 1 is located, and the like, in an identification code management region 17b. Here, the business type and business category code, for example, is a code (sort code) specifying the business type and business category of the store, such as a convenience store, a pharmacy, a restaurant, and the like. Furthermore, this business type and business category is arbitrarily changeable according to the preference of the user. In addition, the company code (identification code of the company which operates the store) and the business type and business category code may also be registered in the electronic receipt server 3.

In addition, the storage unit 17 stores a receipt data schema 17c describing conversion rules when receipt data in a non-structured format is converted into receipt data in a structured format such as XML or CSV (hereinafter, referred to as an electronic receipt). Specifically, in the receipt data schema 17c, elements configuring the receipt data and property information (a tag or the like) indicating properties of each element are defined.

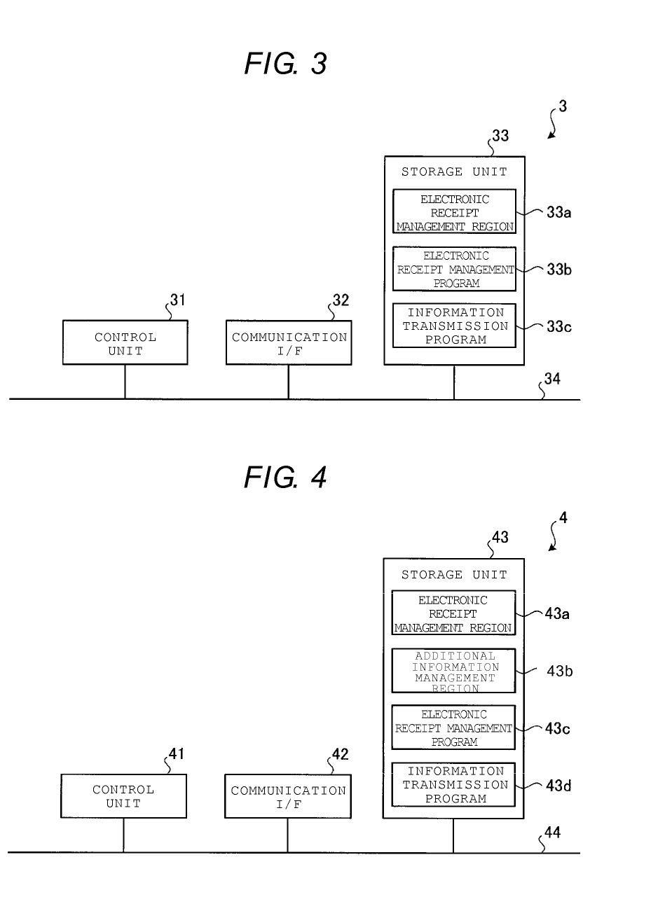

Next, the configuration of the electronic receipt server 3, which functions as a receipt management server for company, will be described with reference to a block diagram of FIG. 3. The electronic receipt server 3 includes a control unit 31 which integrally controls various calculations or each unit of the electronic receipt server 3. The control unit 31 includes a CPU, a ROM storing various programs or data items, a RAM that temporarily stores various programs or rewritably stores various date items, an RTC unit that indicates current date and time, and the like.

The control unit 31 is configured to be connected to the network N2 or the network N3 through the communication I/F 32, which is connected to a bus 34. The control unit 31 is also connected to the storage unit 33 through the bus 34.

The storage unit 33 stores the electronic receipt of a company which operates one or more stores, in an electronic receipt management region 33a. The electronic receipt includes a company code (identification code of the company which operates the stores), a business type and business category code, a store code, a member code of a shopper, a POS number of the POS terminal 1, the receipt number, the merchandise sales data, and the like.

The storage unit 33 also stores an electronic receipt management program 33b for managing the electronic receipt stored in the electronic receipt management region 33a. In addition, the storage unit 33 stores an information transmission program 33c for transmitting the receipt data stored in the electronic receipt management region 33a to the electronic receipt management server 4.

Next, the configuration of the electronic receipt management server 4, which functions as a receipt management server for customers, will be described with reference to a block diagram of FIG. 4. As illustrated in FIG. 4, the electronic receipt management server 4 includes a control unit 41 which integrally controls various calculations or each unit of the electronic receipt management server 4. The control unit 41 includes a CPU, a ROM storing various programs or data items, a RAM that temporarily stores various programs or rewritably stores various data items, an RTC unit that indicates current date and time, and the like.

The control unit 41 is configured to be connected to the network N3, the network N4, and the network N5, through a communication I/F 42 connected to a bus 44. The control unit 41 is also connected to a storage unit 43 through the bus 44.

The storage unit 43 stores the electronic receipt management region 43a for collectively storing the electronic receipt of multiple companies each of which operates one or more stores, in addition to a membership master management region (not illustrated) for storing and managing the membership master. More specifically, the electronic receipt management region 43a is used to manage the electronic receipt of the companies, with respect to each member (customer).

The electronic receipt includes a member code, a company code (identification code of the company which operates the store), a store code, a POS number of the POS terminal 1, a receipt number, the merchandise sales data (including date and time data), and the like. A consumer goods manufacturer or the like may a purchase proof of merchandise associated with the manufacturer from the electronic receipt, in accordance with specific conditions (for example, a specific company which operates the store, a specific location, a specific time, and the like). Here, the consumer goods manufacturer may be a manufacturer of food, drink, clothing, cosmetics, drug, house hold goods, and the like.

In addition, the storage unit 43 stores various kinds of additional information in the additional information management region 43b in correlation with a predetermined merchandise (merchandise code), predetermined membership (member code), a predetermined company (company code), or a predetermined store (store code). Here, the additional information, for example, is purchase incentive information or the like which is added based on the purchase information of the shopper. The purchase incentive information, for example, includes access information (URL or the like) indicating a destination to acquire the purchase incentive (for example, incentive management server 6).

The storage unit 43 also stores an electronic receipt management program 43c for managing the electronic receipt and the additional information of each company, which are stored in the electronic receipt management region 43a and the additional information management region 43b, respectively, in addition to a membership management program (not illustrated) for managing the membership master by a membership master region. The storage unit 43 also stores an information transmission program 43d for transmitting the electronic receipt and the additional information of the predetermined merchandise, to the mobile terminal 7. Furthermore, the membership master management region, the electronic receipt management region 43a, and the additional information management region 43b correspond to the database DB illustrated in FIG. 1.

The electronic receipt management program 43c and the information transmission program 43d, which are executed by the electronic receipt management server 4 according to the present embodiment, are provided in a form of a non-transitory storage medium, such as CD-ROM, flexible disk (FD), CD-R, Digital Versatile Disk (DVD), which is readable by a computer and in a file of an installable format or an executable format.

Alternatively, the electronic receipt management program 43c and the information transmission program 43d which are executed by the electronic receipt management server 4 according to the present embodiment may be stored on a computer connected to a network such as the Internet, and may be provided by being downloaded through the network. In addition, the electronic receipt management program 43c and the information transmission program 43d which are executed by the electronic receipt management server 4 according to the present embodiment may be provided or distributed through the network such as the Internet.

Similarly, the electronic receipt management program 43c and the information transmission program 43d according to the present embodiment may be provided by being incorporated in a ROM or the like in advance.

Next, the configuration of the mobile terminal 7 will be described with reference to a block diagram of FIG. 5. As illustrated in FIG. 5, the mobile terminal 7 includes a control unit 71 which integrally controls various calculations or each unit of the mobile terminal 7. The control unit 71 includes a CPU, a ROM storing various programs or data items, a RAM that temporarily stores various programs or rewritably stores various data items, an RTC unit that indicates current date and time, and the like.

The control unit 71 is connected to an operation unit 72 and a display unit 73 through a bus 76. The operation unit 72 includes various operation keys for the user (customer) to perform input operation, or a pointing device. The display unit 73 is, for example, a liquid crystal display or the like, and displays various kinds of information including the electronic receipt. Furthermore, the display unit 73 may have a touch panel, and in this case, the touch panel functions as the operation unit 72.

The control unit 71 is also connected to a communication I/F 74 through the bus 76, and to the network N5 through the communication I/F 74. Furthermore, the control unit 71 is configured to be connected to the network N1 in the store P1 through the communication I/F 74.

The control unit 71 is also connected to a storage unit 75 through the bus 76. The storage unit 75 stores an electronic receipt correspondence program 75a for receiving the electronic receipt from the electronic receipt management server 4, and an electronic receipt displaying program 75b for displaying the received receipt data, in addition to the Web browser for displaying various kinds of information (content) uploaded on the Web.

Next, an operation of each unit configuring the system according to the present embodiment will be described.

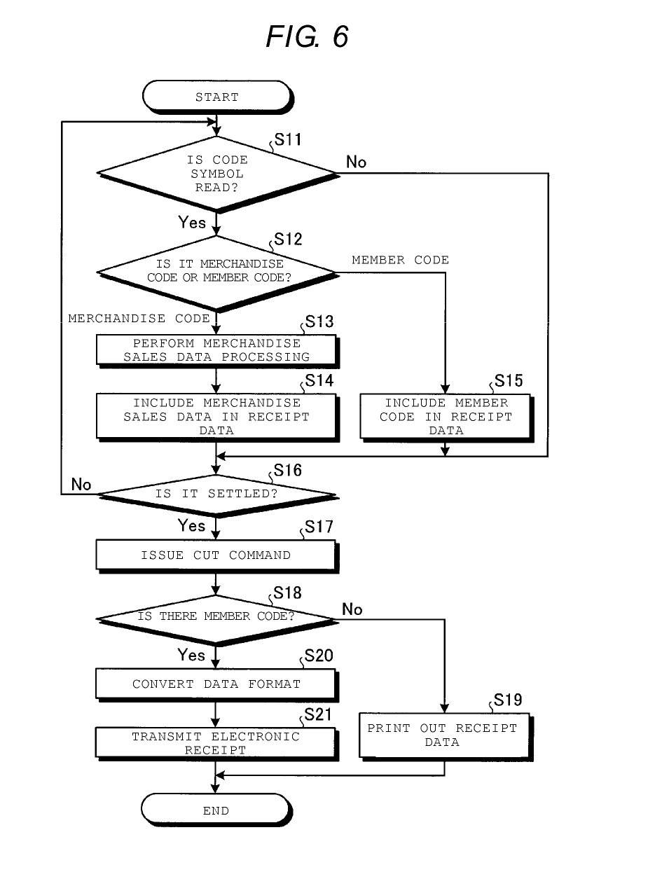

First, electronic receipt processing which is performed when the control unit 11 of the POS terminal 1 executes the receipt data processing program 17a will be described with reference to a flowchart of FIG. 6.

As illustrated in FIG. 6, the control unit 11 of the POS terminal 1 determines whether or not the code symbol printed on the merchandise (merchandise code) or the code symbol (member code) displayed on the mobile terminal 7 is read by the code scanner 15 (Step S11). When the code symbol is not read (Step S11; No), the process proceeds to Step S16.

In contrast, when it is determined that the code symbol is read (Step S11; Yes), the control unit 11 determines whether the read code symbol is the merchandise code or the member code (Step S12).

In Step S12, when the merchandise code is acquired (Step S12; merchandise code), the control unit 11 reads the merchandise data of the merchandise specified by the merchandise code from the merchandise data file, and calculation of the price is performed based on the unit price included in the merchandise data (Step S13). Subsequently, the control unit 11 generates the receipt data including the merchandise sales data which is processed during the merchandise sales data processing (Step S14).

In addition, when the member code is acquired in Step S12 (Step S12; member code), the control unit 11 generates the receipt data including the member code (Step S15).

Here, in order to input the member code into the POS terminal 1, for example, the customer (member) displays the code symbol containing the member code or the like on the display unit 73 of the mobile terminal 7, and the salesperson or the customer scans the code symbol using the code scanner 15 of the POS terminal 1. Furthermore, the control unit 11 may perform exclusive processing or the like such that only one member code is associated with the purchase transaction, when two or more member codes are input.

Subsequently, in Step S16, the control unit 11 determines whether or not the start of the settlement processing is instructed by pressing of the settlement key or the like (Step S16). When the start of the settlement processing is not instructed (Step S16; No), the control unit 11 returns to Step S11. When the start of the settlement processing is instructed (Step S16; Yes), the control unit 11 issues (outputs) a cut command (Step S17).

When the cut command is issued, the control unit 11 determines that the receipt data of one purchase transaction is generated, and determines whether or not the member code is included in the receipt data (Step S18).

When the member code is not included in the receipt data (Step S18; No), the control unit 11 outputs the receipt data of the purchase transaction to the printer 13 along with the cut command, such that the receipt data is printed out (Step S19), and terminates the processing. Then, the printer 13 prints out the receipt data on the paper, and cuts the paper according to the cut command. As a result, the paper receipt of one purchase transaction is printed out.

In contrast, when the member code is included in the receipt data (Step S18; Yes), the control unit 11 generates the electronic receipt by converting the data format of the receipt data, which is a non-structured format, into a structured format based on the conversion rules described in the receipt data schema 17c (Step S20). Then, the control unit 11 transmits the generated electronic receipt to the electronic receipt server 3 through the communication I/F 16 (Step S21), and terminates the processing.

In the processing described above, when the member code is included in the receipt data, the receipt data is output to the electronic receipt server 3, but the configuration is not limited thereto. For example, the receipt data may be output to both of the printer 13 and the electronic receipt server 3.

In addition, when the member code is included in the receipt data, the output destination of the receipt data may be selected. For example, the mobile terminal 7 may store output classification information designating the output destination of the receipt data in the code symbol to be displayed, and instruct the output destination using the code symbol. In this case, the control unit 11 includes the output classification information read by the code scanner 15 in the receipt data along with the member code. When the control unit 11 determines that the member code is included in the receipt data and that the output classification information is also included in the receipt data, the output destination of the receipt data is determined based on the output classification information. Furthermore, any one or both of the printer 13 and the electronic receipt server 3 may be designated in the output classification information.

In addition, the output destination of the receipt data may be selected each time the purchase transaction is performed. In this case, for example, when it is determined that the member code is included in the receipt data, the control unit 11 displays an output destination selection screen for selecting the output destination of the receipt data on the display unit 14.

Furthermore, the display of the selection screen is not limited to the display 14a for an operator, and the selection screen may be displayed on the display 14b for a guest. In addition, when the display 14b for a guest has a touch panel, the customer may select the output destination.

In addition, during the merchandise sales data processing, the customer may select the output destination of the receipt data. In this case, the control unit 11 displays the output destination selection screen (not illustrated) or the like on the display unit 14, and includes a selected output destination in the receipt data as the output classification information. Then, when the member code and the output classification information are included in the receipt data, the control unit 11 determines the output destination of the receipt data based on the output classification information.

As described above, when the member code is included in the receipt data, the control unit 11 automatically selects the output destination of the receipt data, or receives manual selection of the output destination. Accordingly, it is possible to flexibly set a determination method of the output destination.

Next, a flow of the electronic receipt management processing which is performed when the control unit 31 of the electronic receipt server 3 executes the electronic receipt management program 33b and a flow of the information transmission processing which is performed by when the control unit 31 of the electronic receipt server 3 executes the information transmission program 33c will be described with reference to a flowchart illustrated in FIG. 7.

When the electronic receipt, which is transmitted from the POS terminal 1, is received through the communication I/F 32 (Step S31; Yes), the control unit 31 of the electronic receipt server 3 stores the electronic receipt in the electronic receipt management region 33a of the storage unit 33 as (Step S32). Then, the control unit 31 of the electronic receipt server 3 transmits the electronic receipt stored in Step S32 to the electronic receipt management server 4 (Step S33), and returns to Step S31.

In addition, at a transmission timing which is set in advance (Step S31; No→Step S34; Yes), the control unit 31 of the electronic receipt server 3 transmits the electronic receipt stored in the electronic receipt management region 33a to the electronic receipt management server 4 (Step S35), and returns to Step S31. According to the transmission in Step S35, the electronic receipt which is not successfully transmitted in Step S33 may be transmitted to the electronic receipt management server 4. Furthermore, in Step S35, the transmission may be controlled such that only the electronic receipt which has not been successfully transmitted is transmitted.

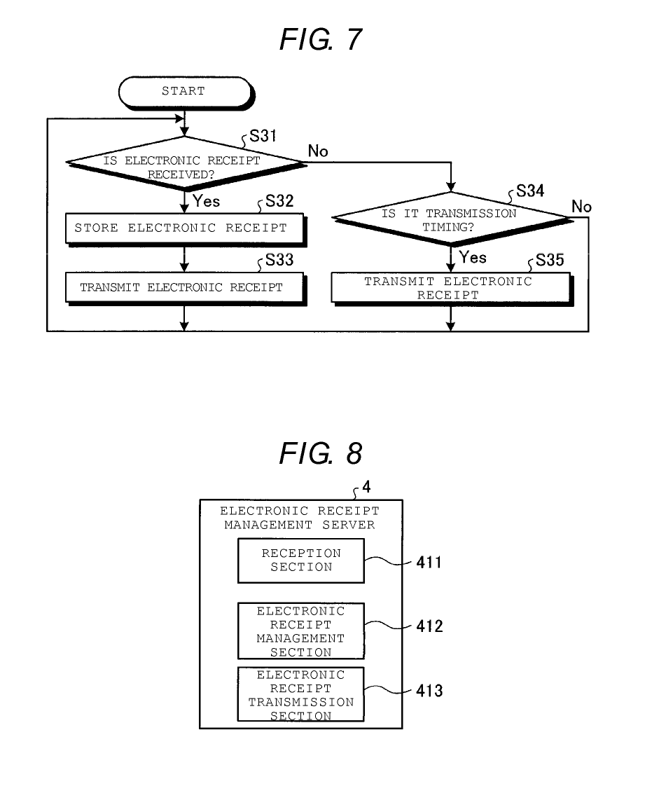

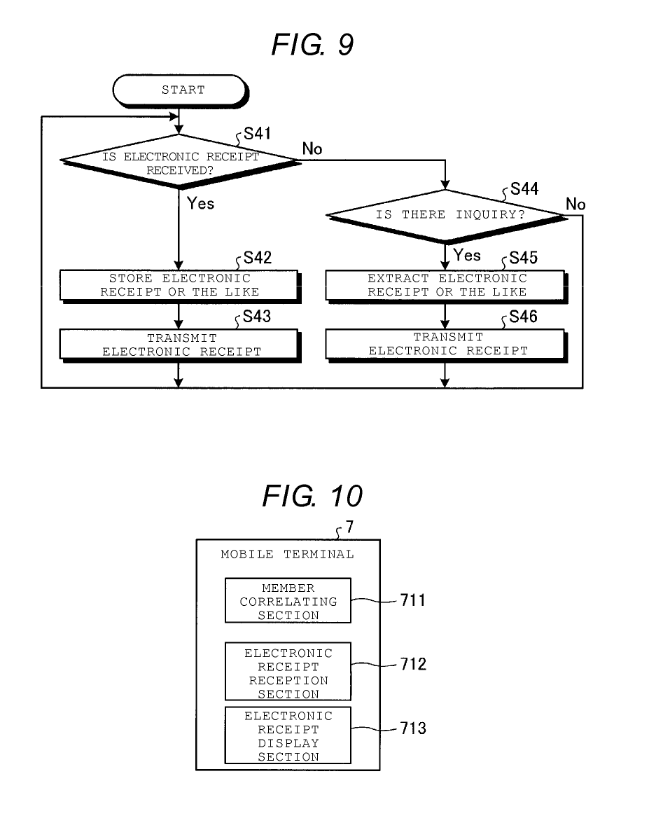

Next, a flow of the electronic receipt management processing which is performed when the control unit 41 of the electronic receipt management server 4 executes the electronic receipt management program 43c and a flow of the information transmission processing which is performed when the control unit 41 of the electronic receipt management server 4 executes the information transmission program 43d will be described with reference to a functional block diagram illustrated in FIG. 8 and a flowchart illustrated in FIG. 9.

As illustrated in FIG. 8, when the electronic receipt management program 43c and the information transmission program 43d are executed by the electronic receipt management server 4, modules including a reception section 411, an electronic receipt management section 412, and an electronic receipt transmission section 413 are generated. As actual hardware, the CPU of the control unit 41 reads the electronic receipt management program 43c and the information transmission program 43d from the storage unit 43 and executes the programs, and thus each of the sections described above is loaded on the RAM, and the reception section 411, the electronic receipt management section 412, and the electronic receipt transmission section 413 are generated on the RAM.

The reception section 411 receives the electronic receipts of multiple companies, each of which includes a company code indicating a company which operates the store and is electronically processed during the merchandise sales data processing instead of a paper receipt or a voucher, from the electronic receipt server 3.

The electronic receipt management section 412 stores and manages the electronic receipts received by the reception section 411, with respect to each company, in the electronic receipt management region 43a of the storage unit 43. In addition, the electronic receipt management section 412 stores and manages the additional information such as the purchase incentive information in the additional information management region 43b of the storage unit 43. The purchase incentive information is correlated with conditions to provide the purchase incentive information based on the past purchase history to the shopper (member) (for example, purchase of target merchandise, a total value of purchase over a threshold value, or a total quantity of target merchandise purchased, and the like).

The electronic receipt transmission section 413 acquires the electronic receipt including one or more company codes correlated with the member code from the electronic receipt management region 43a, and transmits the electronic receipt to the mobile terminal 7 correlated with the member code. In addition, when an element of the electronic receipt satisfies the conditions to provide the purchase incentive information, the electronic receipt transmission section 413 acquires the additional information (purchase incentive information) corresponding to the conditions from the additional information management region 43b, and transmits the additional information along with the electronic receipt.

As illustrated in a flowchart of FIG. 9, the reception section 411 of the electronic receipt management server 4 determines whether or not the electronic receipt transmitted from the electronic receipt server 3 of one of the companies is received through the communication I/F 42 (Step S41).

When the electronic receipt is received (Step S41; Yes), the electronic receipt management section 412 of the electronic receipt management server 4 stores the electronic receipt of the company in the electronic receipt management region 43a of the storage unit 43 (Step S42). Here, when an element of the stored electronic receipt (the merchandise code, the member code, the company code, the store code, quantity of target products, total value of the target product, and the like) and an element of a past electronic receipt during a designated period satisfy the conditions to provide the purchase incentive information, the additional information (purchase incentive information) corresponding to the conditions is correlated.

More specifically, when the electronic receipt is received, the electronic receipt management section 412 of the electronic receipt management server 4 stores the electronic receipt in the electronic receipt management region 43a, and determines whether or not an element of the electronic receipt satisfies the conditions to provide the purchase incentive information (the target merchandise or the like) by referring to a list stored and managed in the additional information management region 43b in advance.

In addition, the electronic receipt management section 412 of the electronic receipt management server 4 analyzes the past electronic receipt generate during the designated period and correlated with the member code, calculates the total value of the target merchandise purchased and the total quantity of the target merchandise purchased, and determines whether or not the conditions to provide the purchase incentive information based on the past purchase history (total value of target merchandise purchased, total quantity of target merchandise purchased, and the like) are satisfied.

Subsequently, the electronic receipt transmission section 413 transmits the electronic receipt stored in Step S42 to the transmission destination (the mobile terminal 7) which is managed in correlation with the member code in the electronic receipt (Step S43), and returns to Step S41. In addition, in Step S43, when the additional information is correlated with the electronic receipt, the additional information is also transmitted to the transmission destination.

In addition, when there is an electronic receipt inquiry from the mobile terminal 7 (Step S41; No→Step S44; Yes), the electronic receipt transmission section 413 of the electronic receipt management server 4 extracts the electronic receipt stored in the electronic receipt management region 43a in response to the content of the electronic receipt inquiry (Step S45), and then transmits the electronic receipt to the mobile terminal 7 which has transmitted the inquiry (Step S46), and returns to Step S41. In addition, in Step S46, when the additional information is correlated with the electronic receipt, the additional information is also transmitted to the mobile terminal 7.

Next, a flow of the electronic receipt reception processing which is performed when the control unit 71 of the mobile terminal 7 executes the electronic receipt correspondence program 75a and a flow of the electronic receipt display processing which is performed when the control unit 71 of the mobile terminal 7 executes the electronic receipt displaying program 75b will be described with reference to FIG. 10 to FIG. 12.

As illustrated in FIG. 10, when the electronic receipt correspondence program 75a and the electronic receipt displaying program 75b are executed by the mobile terminal 7, modules including a member correlating section 711, an electronic receipt reception section 712, and an electronic receipt display section 713 are generated. As actual hardware, the CPU of the control unit 71 reads the electronic receipt correspondence program 75a and the electronic receipt displaying program 75b from the storage unit 75 and executes the programs, and as a result each of the sections described above is loaded on the RAM, and the member correlating section 711, the electronic receipt reception section 712, and the electronic receipt display section 713 are generated on the RAM.

The member correlating section 711 causes the member code of a shopper (user) to be associated with the mobile terminal 7. The electronic receipt reception section 712 receives the electronic receipt from the electronic receipt management server 4. The electronic receipt display section 713 displays the electronic receipt received by the electronic receipt reception section 712 on the display unit 73.

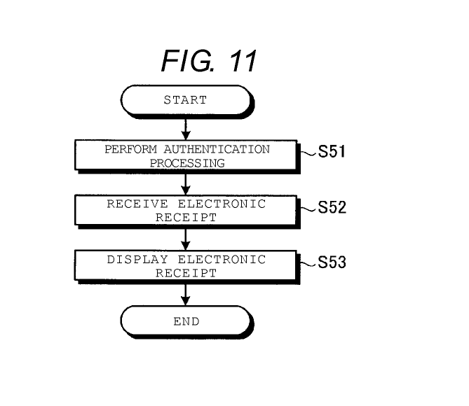

As illustrated in FIG. 11, first, the member correlating section 711 of the mobile terminal 7 accesses the electronic receipt management server 4 and performs the authentication processing by inputting the member code and the password (Step S51). As a result, the mobile terminal 7 is correlated with a member code of a predetermined shopper.

After the authentication, the electronic receipt reception section 712 of the mobile terminal 7 receives the electronic receipt stored in the electronic receipt management region 43a of the electronic receipt management server 4 in association with the input member code (Step S52). When the additional information is correlated with the electronic receipt, the additional information is also received from the electronic receipt management server 4. Here, the receipt data may be received by an email.

Next, the electronic receipt display section 713 of the mobile terminal 7 displays the electronic receipt received by the electronic receipt reception section 712 or the like on the display unit 73 (Step S53), and terminates the processing.

FIG. 12 illustrates an example of an electronic receipt G2 displayed on the display unit 73 of the mobile terminal 7. The electronic receipt G2 is displayed in the same layout or have same contents as that of the receipt printed on the paper. In addition, in the electronic receipt G2, it is possible to select purchased merchandise using a cursor following the input of the operation unit 72. In addition, in FIG. 12, a shop name logo region G21 displaying a logo of a shop name or a banner display region G22 displaying advertisement or the like are included in the electronic receipt G2.

In the present embodiment, it is not necessary that a display mode of the receipt data conforms to the image of the receipt printed on the paper. However, the receipt data is used instead of the paper receipt, and can be a proof of a purchase transaction. Therefore, the receipt data includes following information, so that the electronic receipt can be used as the proof of the purchase transaction.
Store Name
Purchased Date and Time
Details of Purchased Merchandise
Total Price
Amount of Deposit
Amount of Change
Cash Register Number
Transaction Number

Here, when URL (access information) of the incentive management server 6 or the like is set as the additional information with respect to merchandise a, an operation to access the URL is associated with the text of the merchandise a, an icon b, or the like, as operation keys.

For example, when an access destination indicated by the URL is a server device (for example, the incentive management server 6) managing the purchase incentive information, which is added based on the purchase information of the shopper (member), the control unit 71 of the mobile terminal 7 accesses the incentive management server 6 upon the user pressing the icon b or the like, and processing related the acquisition of the purchase incentive is performed. The member code of the own device which is maintained in the receipt data or the like may be transmitted upon accessing the access destination. Then, in the incentive management server 6, the acquisition history of the purchase incentive is managed in correlation with the member code of the member.

Here, the acquisition of the purchase incentive includes acquisition of a discount coupon, a notification of a special sale product of the store, or the like from the incentive management server 6.

Furthermore, when a plurality of receipt data items is received, a selection screen to select one of the receipt data items based on a purchase date, the company code, and the like included in the receipt data may be displayed. In this case, the electronic receipt display unit 713 displays the receipt data selected from the selection screen on the display unit 73.

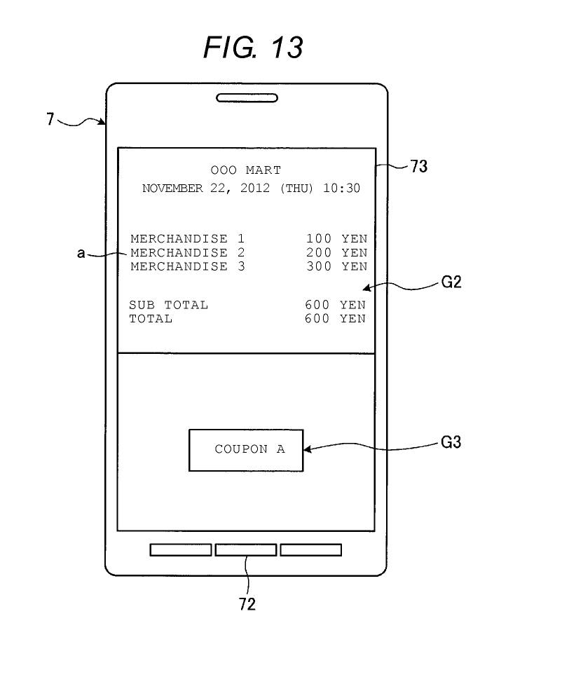

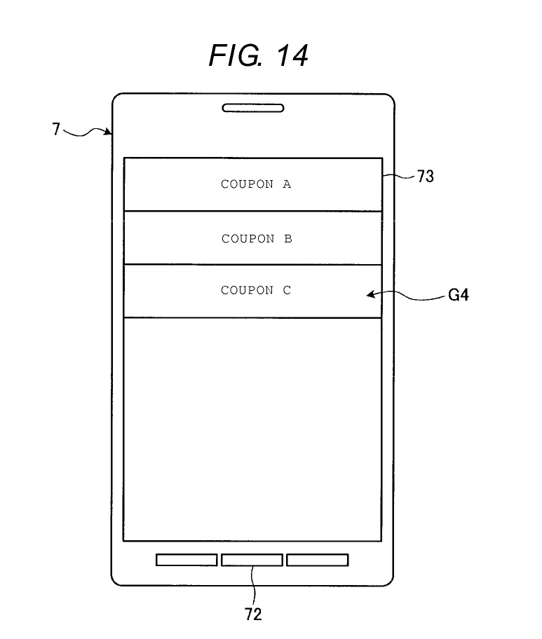

Furthermore, in FIG. 12, the icon b related the acquisition of the purchase incentive is displayed in the vicinity of the merchandise which is a target of the purchase incentive, but the configuration is not limited thereto. For example, as illustrated in FIG. 13, the purchase incentive may be provided in a state where purchase incentive information (for example, a discount coupon, advertisement display, campaign application display, and the like) G3 is displayed below the electronic receipt G2. Alternatively, as illustrated in FIG. 14, purchase incentive information (for example, a discount coupon) G4 may be displayed in a list format, independently from the electronic receipt G2.

Further, when the purchase incentive information (for example, the discount coupon or the like) is added, an incentive providing flag associated with information (a store, a date, a time, and a transaction number) which may identify the electronic receipt as the providing target may be validated. Accordingly, when the purchase incentive information (for example, the discount coupon or the like) is acquired, the corresponding incentive providing flag may be invalidated, and disable execution of right. The purchase incentive information (for example, the discount coupon or the like) in which the execution of right is disabled is no longer displayed on the mobile terminal 7.

As the foregoing illustrates, according to the electronic receipt management server according to the present embodiment, when the element of the electronic receipt information corresponds to the predetermined conditions based on the past purchase result, the additional information about the incentive corresponding to the predetermined conditions is correlated. As a result, retail sellers or the consumer goods manufacturers may perform a promotion according to the past purchase history of the target merchandise (purchase frequency, total quantity of purchases, total value of purchase, and the like), and the consumer may obtain the incentive according to a service with respect to a specific product or a specific consumer goods manufacturer.

According to the present embodiment, by using the electronic receipt system, it is possible to reduce the cost (equipment cost) for providing special equipment (for example, equipment for issuing a discount coupon or the like) in the vicinity of the merchandise sales data processing device of the POS terminal 1 or the like. Further, it is not necessary to introduce a separate customer management system.

According to the present embodiment, it is possible to providing the purchase incentive not based on a purchase history in one retail seller, but based on a purchase history in a plurality of retail sellers in the electronic receipt system.

In addition, in the embodiment described above, the electronic receipt server 3 is located in the head office P2, but the configuration is not limited thereto. For example, the electronic receipt server 3 for the store P1 may be located in the store P1. In this case, the POS terminal 1 outputs the electronic receipt to the electronic receipt server 3 which is connected to the network N1 in the store, and the electronic receipt server 3 transmits the electronic receipt to the electronic receipt management server 4 through the network N1 in the store P1 and the network N2.

In addition, in the embodiment described above, the electronic receipt generated by the POS terminal 1 is output to the electronic receipt management server 4 through the electronic receipt server 3, but the configuration is not limited thereto. For example, the electronic receipt may be directly output to the electronic receipt management server 4 upon access to the electronic receipt management server 4 from the POS terminal 1 through the network N3.

In addition, in the embodiment described above, the mobile terminal 7 receives the electronic receipt through the electronic receipt management server 4, but the configuration is not limited thereto, and the electronic receipt may be directly received from the POS terminal 1. In this case, the POS terminal 1 outputs the generated electronic receipt to the mobile terminal 7 which is connected through the network N1 in the store P1 or a near field communication unit (not illustrated). In addition, in this case, the authentication processing may be performed by the POS terminal 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A mobile computing device that is connected to a central server over a network, comprising:
a wireless communication unit through which requests are transmitted to the central server and responses are received from the central server;
a touch screen on which a graphical user interface is displayed; and
a processing unit that is programmed to generate the graphical user interface on the touch screen, the graphical user interface including a plurality of user interface elements, each of which triggers the processing unit to execute instructions that are predetermined to be executed when the user interface element is touched,
wherein a touching of one of the user interface elements causes the processing unit to generate an updated graphical user interface displaying an user interface element associated with content prompting a future transaction, and
wherein the content is generated remotely at the central server according to user profile data that has been collected over time by the central server, such that the content generated remotely at the central server at a first time is different from the content generated remotely at the central server at a second time subsequent to the first time, and the content generated remotely at the central server at the first time has a higher correlation to the user profile data at the first time than the user profile data at the second time and the content generated remotely at the central server at the second time has a higher correlation to the user profile data at the second time than the user profile data at the first time.

2. The mobile computing device according to claim 1, wherein
a touching of the user interface element in the updated graphical user interface causes the communication unit to access a destination in the network associated with the content and download the content.

3. The mobile computing device according to claim 2, wherein
the touching of the user interface element in the updated graphical user interface further causes the touch screen to display the downloaded content.

4. The mobile computing device according to claim 1, wherein
the updated graphical user interface also displays an electronic receipt of a past transaction, and the user interface element is overlaid on the electronic receipt.

5. The mobile computing device according to claim 4, wherein
the content is associated with a product,
the electronic receipt includes texts indicating the product as a product purchased through the past transaction, and
the user interface element is overlaid adjacent to the texts.

6. The mobile computing device according to claim 1, wherein
the updated graphical user interface includes a first region in which the user interface element is displayed and a second region that is different from the first region and displays an electronic receipt of a past transaction.

7. The mobile computing device according to claim 1, wherein
the updated graphical user interface displays a plurality of user interface elements separately from an electronic receipt of a past transaction, the user interface elements being associated with different contents prompting future transactions.

8. The mobile computing device according to claim 1, wherein
the content is an electronic coupon of a product registered in the central server.

9. A method for displaying content prompting a future transaction on a mobile computing device that is connected to a central server over a network, the method comprising:
generating a graphical user interface on a touch screen of the mobile computing device, the graphical user interface including a plurality of user interface elements, each of which triggers to execute instructions that are predetermined to be executed when the user interface element is touched;
generating, on the touch screen, an updated graphical user interface displaying an user interface element associated with content prompting a future transaction, in response to a touching of one of user interface elements in the graphical user interface; and
displaying the content on the touch screen, in response to a touching of the user interface element in the updated graphical user interface, wherein
wherein the content is generated remotely at the central server according to user profile data that has been collected over time by the central server, such that the content generated remotely at the central server at a first time is different from the content generated remotely at the central server at a second time subsequent to the first time, and the content generated remotely at the central server at the first time has a higher correlation to the user profile data at the first time than the user profile data at the second time and the content generated remotely at the central server at the second time has a higher correlation to the user profile data at the second time than the user profile data at the first time.

10. The method according to claim 9, further comprising:
accessing a destination in the network associated with the content, in response to the toughing of the user interface element in the updated graphical user interface; and
downloading the content, wherein
the downloaded content is the content displayed on the touch screen.

11. The method according to claim 9, wherein
the updated graphical user interface also displays an electronic receipt of a past transaction, and the user interface element is overlaid on the electronic receipt.

12. The method according to claim 11, wherein
the content is associated with a product,
the electronic receipt includes texts indicating the product as a product purchased through the past transaction, and
the user interface element is overlaid adjacent to the texts.

13. The method according to claim 9, wherein
the updated graphical user interface includes a first region in which the user interface element is displayed and a second region that is different from the first region and displays an electronic receipt of a past transaction.

14. The method according to claim 9, wherein
the updated graphical user interface displays a plurality of user interface elements separately from an electronic receipt of a past transaction, the user interface elements being associated with different contents prompting future transactions.

15. A mobile computing device that is connected to a central server over a network, comprising:
a wireless communication unit through which requests are transmitted to the central server and responses are received from the central server;
a touch screen on which a graphical user interface is displayed; and
a processing unit that is programmed to generate the graphical user interface on the touch screen, the graphical user interface including a plurality of user interface elements, each of which triggers the processing unit to execute instructions that are predetermined to be executed when the user interface element is touched,
wherein a touching of one of the user interface elements causes the processing unit to generate an updated graphical user interface displaying content prompting a future transaction, and
wherein the content is generated remotely at the central server according to user profile data that has been collected over time by the central server, such that the content generated remotely at the central server at a first time is different from the content generated remotely at the central server at a second time subsequent to the first time, and the content generated remotely at the central server at the first time has a higher correlation to the user profile data at the first time than the user profile data at the second time and the content generated remotely at the central server at the second time has a higher correlation to the user profile data at the second time than the user profile data at the first time.

16. The mobile computing device according to claim 15, wherein
a touching of the content in the updated graphical user interface causes the touch screen to display an expanded image of the content.

17. The mobile computing device according to claim 15, wherein
the updated graphical user interface also displays an electronic receipt of a past transaction, and the content is overlaid on the electronic receipt.

18. The mobile computing device according to claim 15, wherein
the updated graphical user interface includes a first region in which the content is displayed and a second region that is different from the first region and displays an electronic receipt of a past transaction.

19. The mobile computing device according to claim 15, wherein
the updated graphical user interface displays a plurality of user interface elements separately from an electronic receipt of a past transaction, the user interface elements being associated with different contents prompting future transactions.

20. The mobile computing device according to claim 15, wherein
the content is an electronic coupon of a product registered in the central server.
